(19) United States
(12) Patent Application Publication
(10) Pub. No.: US 2024/0165734 A1
(43) Pub. Date: May 23, 2024

(54) Method for Joining Components, and Component Connection

(71) Applicant: Bayerische Motoren Werke Aktiengesellschaft, Muenchen (DE)

(72) Inventors: Manuel ANASENZL, Mainburg (DE); Andreas BRENNINGER, Geisenhausen (DE); Christian HAGEN, Landshut (DE); Joachim MEESS, Ergoldsbach (DE); Klaus SAMMER, Malgersdorf (DE)

(21) Appl. No.: 18/549,275

(22) PCT Filed: Feb. 16, 2022
(86) PCT No.: PCT/EP2022/053723

§ 371 Date: Sep. 6, 2023

(30) Foreign Application Priority Data
Mar. 16, 2021 (DE) 10 2021 106 365.5

(51) Int. Cl. B23K 11/16; B23K 11/11; B23K 35/00; B23K 103/20

(52) U.S. Cl. CPC B23K 11/163; B23K 11/115; B23K 35/001; B23K 2103/20

(57) ABSTRACT

A method for joining components includes providing a first component where the first component is an aluminum die-cast component and has a joining region for disposing and fastening a second component, generating at least in regions an adhesive layer on the joining region by a thermal spraying method, and fastening the second component to the adhesive layer by joining by pressure welding.

### BACKGROUND AND SUMMARY OF THE INVENTION

The present invention relates to a method for joining components, and to a component connection as is used in the construction of bodywork/vehicles, for example.

Steel/aluminum connections are used in the construction of bodywork so as to keep down the weight of parts, components and structures, etc. Customary joining or connecting methods in this context include riveting, in particular (semi-tubular) self-piercing riveting, clinching, (flow-drilling) screwing, adhesive bonding, or combinations of these methods. It is a common feature of the aforementioned methods that the latter do not represent the optimum in terms of cycle time and investment costs. Moreover, the complexity in terms of construction is often high in order to generate connections of sufficient stiffness and strength.

It is, therefore, an object of the present invention to specify a method for joining components and a component connection, which meet the highest mechanical requirements and offer optimized cycle times and low investment costs.

According to the invention, a method for joining components, in particular at least two components of dissimilar raw materials or materials, comprises the steps:
providing a first component, in particular an aluminum die-cast component, wherein the first component has a joining region for disposing and fastening a second component;
generating at least in regions an adhesive layer on the joining region by means of a thermal spraying method;
fastening a second component to the adhesive layer by joining by means of pressure welding.

In pressure welding, two workpieces or components to be connected are heated to melting point and connected to one another by compression. In this context it is particularly advantageous that no additional materials such as, for example, a welding wire are required during pressure welding, as a result of which costs can be saved. Moreover, no notable increase in weight arises during joining, because no additional material is required as in the case of riveting, for example. The welding time is advantageously only a few milliseconds so that very short cycle times can be implemented in production.

In this context, resistance welding, in particular resistance spot welding, is a particularly advantageous method. Here, the two components are compressed by two electrodes. The welding spot between the electrodes is heated to the required temperature by means of the flow of current. The shape and strength of the nugget depend on the three central welding parameters, i.e., current, time and contact pressure. In resistance spot welding, a high energy is concentrated on a small area within the shortest time, and a non-releasable connection is achieved in combination with pressure generated pneumatically, hydraulically, by servomotors or solenoids.

A further preferred welding method is inter alia capacitor discharge welding.

According to one embodiment, the electrodes of the welding tool (in particular for resistance spot welding) presently preferably have welding caps of dissimilar shapes. According to one embodiment, a spherical welding cap is used on the side of the aluminum material, and a flat welding cap is used on the side of the steel material. It has been demonstrated that an optimal welding result can be achieved with this configuration. Impressions on the aluminum material can advantageously be avoided. Sticking of the welding caps is also effectively avoided. Cap shapes deviating therefrom can likewise be expedient.

The application of the adhesive layer advantageously enables the connection of dissimilar basic materials or materials and/or of basic materials or materials of different types. In this way, a welded connection for example between an aluminum component and a steel component is in particular made possible with little complexity. A steel material, or a material based on iron/steel, is advantageously used as the material for the adhesive layer. According to one preferred embodiment, an austenitic (stainless) steel, and particularly preferably a ferritic (stainless) steel, is used as the material for the adhesive layer. In the present case, a casting from an aluminum material, in particular an aluminum die-cast component, is particularly preferably provided with the adhesive layer.

The thermal spraying method is a surface treatment method. Here, additives, so-called spray additives, are fused or melted within or outside a burner gun and in the form of spray particles accelerated in a flow of gas. The component surface is not melted in the process. This results in low thermal stress. A layer is formed because the spray particles when impacting the component surface are more or less flattered, depending on the process and the material, adhere to the component surface primarily as a result of mechanical interlocking, and build up the sprayed layer layer-by-layer. An electric arc (arc spraying), a plasma jet (plasma spraying), a fuel-oxygen flame, or a high-velocity fuel-oxygen flame (conventional and high-velocity flame spraying), rapidly pre-heated gases (cold gas spraying), and a laser jet (laser jet spraying) serve as an energy source for fusing or melting the spray additive. The combination of thermal coating methods and press welding methods for connecting in particular basic materials or materials of different types enables particularly short cycle times and low investment costs.

Cold gas spraying has proven to be a particularly advantageous coating method in the present case. According to one preferred embodiment, the operation is carried out with temperatures of the gas jet being beyond 800° C. Preferred maximum temperatures are in the range of 1200° C. so that this results in an overall preferred temperature range between approximately or above 800° C. and approximately 1200° C. Tests have demonstrated that temperatures in the range of approximately 1000° C. are optimal for the coating quality. Surfaces which have an optimal structure for the downstream joining processes can advantageously be achieved by cold gas spraying.

According to one preferred embodiment, the method comprises the steps:
generating an adhesive layer extending along the joining region in such a manner that the adhesive layer along the joining region has a profiled surface, structured surface, or a wave profile;
spot welding, in particular resistance spot welding, in the region of the wave crests of the adhesive layer.

The adhesive layer along the joining region advantageously does not have a constant thickness or wall thickness. In the regions where a welding spot is to be placed, presently referred to as plateau, wave crest or field, the adhesive layer is expediently of a thicker configuration, while the portions between these regions are preferably of a thinner configuration. In this way, coating material can advantageously be saved, as a result of which weight and costs can be reduced. Alternatively, the adhesive layer along the joining region may also have a constant thickness. Furthermore alternatively, the adhesive layer can be configured in regions along the joining region. In this instance, no adhesive layer is configured between the afore-mentioned wave crests, etc.

The profiled surface or structured surface of the adhesive layer along the joining region is expediently designed in such a manner that the adhesive layer in the region of a welding spot has, for example, a thickness of preferably approximately 500 μm to 2500 μm, particular preferably of approximately 800 μm to 1500 μm, and particularly preferably of approximately 1000 μm. The extent of the adhesive layer in this region, in the plan view from above, is approximately 20 mm×20 mm. Variances above as well as below these values are possible, depending on the type of the components to be joined. However, it has been demonstrated that the afore-mentioned size enables production in manner particularly reliable in terms of the process. In this context, the design of the welding method is decisive, the latter preferably being carried out in an automated manner by at least one robot. The robot, in the present case particularly preferably a 6-axis or 7-axis industrial robot, when placing the welding spots has a certain tolerance in terms of the position of the welding spots, in particular by virtue of the high displacement velocities, this tolerance advantageously being able to be compensated by way of a size of the afore-mentioned plateaus, wave crests or fields.

The adhesive layer preferably comprises the wave crests, plateaus or fields at preferably regular spacings along the joining region. The in particular regular spacing of the wave crests, plateaus or fields, in terms of the centers of the latter, according to preferred embodiments is in a range from approximately 40 to 70 mm, particularly preferably in a range from approximately 55 to 60 mm. In the construction of bodywork and vehicles, this spacing has proven advantageous for achieving mechanical objectives.

According to one preferred embodiment, the afore-mentioned spacing is reduced or increased at least in portions along the adhesive layer. The spacing in functionally critical regions is particularly preferably approximately 15 to 25 mm, in particular approximately 20 mm.

Depending on the design of the coating method, the wave crests, plateaus or fields have approximately the shape of flat cuboids, wherein a cuboid expediently has lateral lengths of approximately 20 mm×20 mm, as already mentioned, and a height of approximately 1000 μm. In principle, the adhesive layer preferably has a width in a range from approximately 10 to 30 mm, particularly preferably in a range from 15 to 25 mm, or 20 mm, for example. The width of the afore-mentioned “cuboids” is automatically derived in this way, the surface of the latter potentially being rectangular or square, for example.

According to preferred embodiments, the adhesive layer is of a thinner configuration between the wave crests, plateaus or fields. Alternatively, the adhesive layer along the joining region can also have a uniform or at least an approximately uniform thickness, as has already been mentioned. The regions between the wave crests, plateaus or fields are presently referred to as wave troughs, intermediate spaces or pockets. The thickness of the adhesive layer between the wave crests, plateaus or fields according to preferred embodiments is in a range from approximately 200 μm to 2200 μm, in particular preferably of approximately 600 μm to 1200 μm, and particularly preferably approximately 700 μm.

The present thickness or height specifications are mean values in the respective ranges.

According to one preferred embodiment, the ratio of the height of a wave crest to the height of a wave trough is in a range from approximately 1.05 to 2.7, particularly preferably in a range from approximately 1.1 to 1.9, and most particularly preferably about 1.3 to 1.6, in particular approximately 1.4 to 1.45.

The wave crests and wave troughs along the adhesive layer preferably have the same height, taking into consideration production tolerances.

According to one preferred embodiment, the profiled surface, structured surface or the wave profile is generated by an appropriately adapted advancement speed while coating. The (coating) method advantageously comprises the steps:
generating a wave crest, plateau or field by way of an in particular constant advancement speed v1 of the coating tool, such as a spray lance, for example;
accelerating the coating tool to an advancement speed v2, greater than v1, whereby a reduced application of coating material automatically occurs by virtue of the preferably continuous conveyance of the coating material;
traveling at the advancement speed v2;
decelerating the coating tool to the speed v1 for generating the next wave crest.

Consequently, transitions in which the thickness of the adhesive layer increases or decreases are created between the wave crests and the pockets or intermediate spaces. A thickness of the adhesive layer in the intermediate spaces, pockets or troughs can be adapted depending on the process management, for example by way of a corresponding choice of nozzle and/or by adapting the displacement speed v2 while coating.

According to one embodiment, the adhesive layer along the joining region is configured intermittently or in portions. In this case, an adhesive layer for shaping the wave crests, plateaus or fields is configured only in portions. No adhesive layer is configured therebetween.

According to one embodiment, the profiled surface, structured surface or the wave profile is (also) generated in that masking of the joining region takes place in portions. This can be expedient in particular when an intermittent adhesive layer is to be generated. Material separated on the mask can advantageously be reused or recycled, or be supplied to another process, so that the use of resources is minimized here too.

According to one embodiment, the method comprises the step:
generating the adhesive layer by way of a material application in a plurality of tracks disposed next to one another (along the joining region).

The width of the adhesive layer which, according to preferred embodiments, is in a range of approximately 20 mm, as already mentioned, can be generated in one pass in the case of a corresponding nozzle geometry. A flat nozzle with a corresponding width is advantageously used here. This can be implemented more easily the narrower the width. It has proven advantageous to use a nozzle geometry with a rectangular cross section. The nozzle here is aligned in such a manner that the long side of the rectangle is oriented transversely to the advancement direction. The width of the rectangle determines the width of the adhesive layer. Alternatively, the adhesive layer can be generated by applying material in a plurality of tracks disposed next to one another. Nozzle geometries with round, in particular circular, cross sections (round nozzles) are preferably used here.

The method preferably comprises the step:
adapting the offset of the traces in the material application in a plurality of tracks in such a manner that the adhesive layer, in particular in the width direction, thus transversely to the advancement direction, has a uniform surface.

As a result, problems during welding can advantageously be avoided. If the offset of the traces is excessive, impermissibly large gaps may potentially be generated between the individually applied tracks, which potentially may unfavorably influence the flow of current between the electrodes during welding, whereby welding spatters can be created, among other things. A trace offset of approximately 1 mm at a nozzle diameter of approximately 8 mm has proven advantageous. Surface roughness values which are preferably to be achieved will be mentioned at a later stage.

According to one embodiment, the adhesive layer is generated in one pass. Alternatively, a plurality of passes are required. The adhesive layer is built up in the thickness direction, thus potentially layer-by-layer or tier-by-tier.

In principle, the adhesive layer may comprise a plurality of layers or tiers. The tiers/layers can be applied or generated in a plurality of passes. The tiers/layers can comprise or be composed of dissimilar materials/basic materials.

According to one embodiment, the method comprises the steps:
generating the adhesive layer by means of a thermal spraying method, in particular cold gas spraying;
applying a functional layer to the adhesive layer, preferably by means of a thermal spraying method, in particular likewise by means of cold gas spraying.

The functional layer is preferably configured as an anti-corrosion layer. Zinc or a zinc compound is preferably provided as material to this end. The functional layer is expediently a zinc layer.

Alternatively, the adhesive layer, or the first component as such, is oil-treated.

According to one embodiment, an intermediate layer is configured between the adhesive layer and the first component. The intermediate layer can likewise be generated by a thermal spraying method such as cold gas spraying, in particular. The intermediate layer is preferably conceived to avoid contact corrosion between the first component and the adhesive layer. A migration of iron (Fe) into the aluminum material (Al) is preferably avoided, as a result of which Fe—Al phases which are unfavorable due to brittleness can be avoided.

According to one embodiment, the method comprises the step:
fastening the second component to the joining region by additional joining by means of adhesive bonding.

It is to be pointed out at this stage that the region in which the two components overlap is interpreted as the joining region, for example. Accordingly, the joining region can also be considered to be a flange or flange portion, or flange region, respectively. The adhesive layer can extend about or along the entire joining region. Alternatively, only regions or parts of the joining region are provided with the adhesive layer. In terms of the application of the cement this means that the cement can be disposed in such a manner that the cement connects only the first and the second component.

The cement is particularly preferably applied in such a manner that the cement also contacts the adhesive layer, thus in particular provides a connection between the adhesive layer and the second component. This is particularly advantageous because the adhesive layer for process-related reasons has a roughness which is optimal in terms of the adhesion of the cement. The roughness, or the resultant enlargement of the surface, respectively, offers best preconditions for the application of cements.

According to one embodiment, the method comprises the step:
applying cement to and/or beside the adhesive layer.

As has already been mentioned, contact between the cement and the adhesive layer is particularly recommended. In this context, the profiled surface, structured surface or the wave profile of the adhesive layer is also particularly advantageous, which apart from the afore-mentioned wave crests, plateaus or fields, which serve as welding spots, has therebetween the wave troughs, pockets or intermediate spaces. These intermediate spaces or chambers can serve in an optimal manner as cement reservoirs which are filled with cement at least in portions or regions. An optimal thickness of the cement layer in these regions can advantageously be adjusted by way of the thickness of the adhesive layer in the region of the wave troughs. According to preferred embodiments, the thickness of the cement layer is approximately 200 to 400 μm, in particular approximately 300 μm. The wave troughs, or the ratio of the height of the wave crests to the wave troughs, respectively, are accordingly configured. Added to this are the advantages which the rough surface structure of the adhesive layer offers in the first place. It is to be mentioned here that this effect also arises when the cement bears laterally on the adhesive layer. Accordingly, the cement can also be applied or disposed beside the adhesive layer. The corresponding distribution can then take place when the components are compressed.

According to one embodiment, the method comprises the step:
applying cement in a punctiform manner to the wave crests.

Here, a corresponding quantity of cement is advantageously applied to the wave crests. This notwithstanding the fact that an application of cement, even of a minor quantity, can also occur between the wave crests during the application, for example as a result of dripping.

The application of cement particularly preferably takes place linearly and continuously along the adhesive layer. In this case the displacement speed is preferably decreased in the region of the wave troughs, because more cement is expediently supplied here.

According to one preferred embodiment, a pre-distribution of the cement takes place by disposing or positioning the components on one another. A separate method step for distributing the cement can expediently be dispensed with. Instead, the cement is supplied to a desired location so as to then be distributed while joining the components.

According to one embodiment, the method comprises the step:
final distribution of the cement by the introduction of force when welding the components.

This introduction of force is implicitly a component part of the pressure welding method so that a special or separate method step is advantageously also not required here.

When viewed along the joining region, the cement seam according to one embodiment is embodied in such a manner that the cement seam completely seals the joining region toward one side (K1 cement seam). Alternatively, the cement seam, or a plurality of cement seams, is/are disposed in such a manner that the joining region is completely sealed toward both sides (K2 cement seam). Expediently, or according to one preferred embodiment, respectively, the adhesive layer is completely embedded in cement, in other words encapsulated in the cement. The configuration of the final cement seams is expediently determined by the application of cement.

According to one embodiment, a single-component cement or a bi-component cement is used. Structural cements are preferably used in particular. The single-component cement requires heat for curing. This single-component cement has not cured after welding. Instead, the single-component cement can cure for example in a subsequent painting process. A bi-component cement is cured by air. The flexibility in terms of the material to be used enables high degrees of freedom in particular in terms of the design embodiment of the components.

According to one embodiment, the method comprises the steps:
providing a first component with a surface treatment;
removing in regions the surface treatment by and while generating the adhesive layer.

A surface treatment of the type being discussed can be a CDP (cathodic dip painting) layer, a passivation, or laser cleaning or laser activating of the component surface, for example. It has been demonstrated that the afore-mentioned types of “coatings” can in particular be removed or subtracted by way of the thermal spraying method. In other words, a surface treatment of any type does not interfere with the application of the adhesive layer, whereby the preferably high gas temperatures of more than 800° C., in particular preferably approximately 1000° C., of the gas jet, in particular during cold gas spraying, also come to bear at this point.

Alternatively, the initially at least partially bright or non-coated components are joined and only subsequently fed to a coating method, the latter serving the purpose of corrosion protection, for example. According to one embodiment, the method comprises the step:
applying a surface treatment to the first component after joining the components.

The invention also relates to a component connection, comprising a first component, in particular from an aluminum material, and a second component, in particular from a steel material, which are fastened to one another along a joining region, wherein the first component in the joining region at least in regions has an adhesive layer which is generated by means of a thermal spraying method, and wherein the second component is fastened to the adhesive layer by means of pressure welding. The first component from an aluminum material with the aid of the spraying method is advantageously provided with a steel coating/adhesive layer so as to subsequently be connected to the second component, expediently from steel, by means of pressure welding, in particular resistance spot welding. The first component is particularly preferably an aluminum die-cast component. The latter can have a surface treatment such as a CDP coating, a passivation, or laser activating/laser cleaning, etc.

According to preferred embodiments, the first component is a casting, a metal sheet and/or else a profile, preferably from a light metal such as an aluminum material. Preferred castings are in particular structural components such as spring supports, side beams, or cast nodes (for example the A-pillar of a motor vehicle). Moreover, castings of the type discussed may also be complete frames, rear ends or front ends of motor vehicles. First components can also be housings of electric energy stores, in particular high-voltage storage housings, in particular preferably the upper parts or lower parts of housings of this type.

According to one preferred embodiment, the adhesive layer extends along the joining region and along the joining region has a profiled surface, structured surface or a corrugation, wherein preferably at least one welding spot is in each case configured on the wave crests. The adhesive layer along the joining region preferably has alternating wave crests and wave troughs, wherein one or at least one welding spot is in each case disposed on the wave crests.

According to one preferred embodiment, the surface of the adhesive layer, or in particular of a wave crest, has a Sa value of preferably more than 5 μm, particularly preferably between 5 and 35 μm, and in particular preferably between 5 and 15 μm. The Sa value (mean arithmetic height) is the value of the difference in height of each point in comparison to the arithmetic mean of the surface. In this way, a welding process which is reliable in terms of the process can be ensured. It can be ensured in this way in particular that a continuous current path is not impeded by any potential breaches or gaps.

The Sdr value of the adhesive layer is preferably at least 5%, particularly preferably in a range from 10 to 30%, and in particular preferably approximately 12 to 20%. This parameter is a percentage of the additional area of the definition region that can be traced back to the surface characteristic of the adhesive layer, in comparison to the absolutely planar definition region. For example, the Sdr value of a non-treated die-cast component is in a range of 2%.

According to one preferred embodiment, the components are adhesively bonded at least in regions along the joining region, in particular along the adhesive region. The cement is preferably in contact with the adhesive layer. The advantage that the adhesive layer has a greater roughness than the first component is utilized here.

Moreover, the advantages and features mentioned in the context of the method apply correspondingly in an analogous manner to the component connection and vice versa.

Further advantages and features are derived from the description hereunder of embodiments of methods for joining components, or of a component connection, with reference to the appended figures.

### BRIEF DESCRIPTION OF THE DRAWINGS

FIG. 1 shows a schematic view of an embodiment of a method sequence;

FIG. 2 shows a schematic view of two components prior to joining;

FIG. 3 shows the components known from FIG. 2 after joining;

FIG. 4 shows a schematic sectional view of an adhesive layer; and

FIG. 5 shows a schematic sectional illustration of an adhesive layer when viewed along an advancement direction.

### DETAILED DESCRIPTION OF THE DRAWINGS

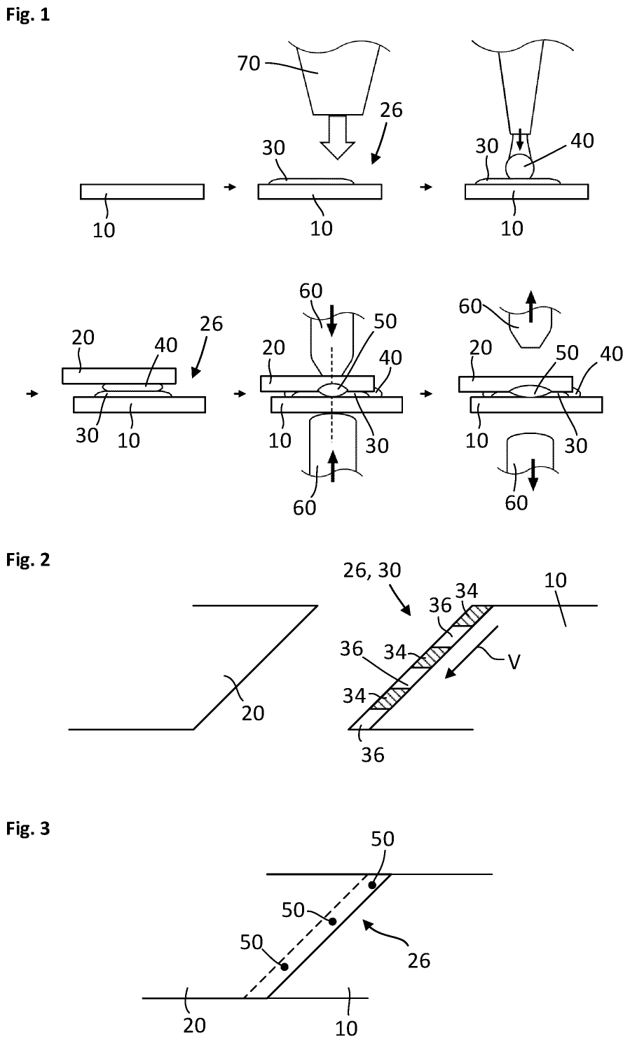

FIG. 1 in a schematic illustration shows an embodiment of a method sequence for joining two components 10 and 20. A first component 10 is schematically illustrated. An adhesive layer 30 is applied to a joining region 26 of the first component 10 by way of a thermal coating or spraying method, cf. the coating tool 70. Cement 40, which is pre-distributed while positioning a second component 20 on the joining region 26, is applied directly to the adhesive layer 30. The joining of the two components 10 and 20 subsequently takes place by means of pressure welding, presently in particular resistance spot welding, cf. the two welding caps 60. In the context of the welding process, the two components 10 and 20 are pressed against one another by way of the introduction of force, cf. the arrows directed toward one another, wherein the cement 40 is further distributed and now advantageously completely encapsulates the adhesive layer 30. It can be seen that the welding caps 60 are of dissimilar configurations. The lower welding cap 60, which bears on the first component 10, thus preferably the aluminum material, is spherically embodied, while the upper welding cap 60, which bears on the second component 20, thus the steel material, is configured to be flat or planar. This design embodiment has proven advantageous because an impression on the aluminum side can be avoided in this way. Moreover, it can effectively be prevented that the welding caps 60 stick. The last image shows the removal of the welding caps 60 as is indicated by the two arrows. The two components 10 and 20 are now connected by way of the welding spot 50 and by way of the cement 40. It can be seen that the cement 40 bears on the adhesive layer 30, in particular circumferentially thereon, but also on the two components 10 and 20.

FIG. 2 in a schematic view shows a second component 20 and a first component 10. An adhesive layer 30 extends along a joining region 26 along the first component 10. The adhesive layer 30 is generated by way of a thermal spraying method. For this purpose, the joining region 26 is traveled along a displacement direction V by a corresponding tool and the adhesive layer 30 is applied. This can be performed in a plurality of layers which are applied on top of one another. The required thickness of the adhesive layer 30 is preferably generated in one pass. The width of the adhesive layer 30, which is measured transversely to the displacement direction V, can be covered by being passed over in a plurality of tracks or traces lying next to one another, wherein a plurality of layers can be applied on top of one another here too. In the case of a corresponding choice of nozzle, the width can alternatively be adjusted in one pass. The adhesive layer 30 along the displacement direction V is expediently designed in such a manner that the adhesive layer 30 forms a profiled surface, structured surface or a wave profile. This wave profile comprises wave crests 34 and wave troughs 36. A thickness of the adhesive layer 30 in the region of the wave crests 34, cf. the hatched fields, is greater than in the wave troughs 36. According to preferred embodiments, the thickness of the adhesive layer 30 in the region of the wave crests 34 is approximately 1000 μm. The thickness of the adhesive layer 30 in the intervening wave troughs 36 is below this value or may even tend to be 0, depending on the process management. The function of the structured surface will become evident in particular with a view to FIG. 3. The wave crests 34, also referred to as plateaus or fields, in the plan view from above have a lateral length of preferably 20 mm×20 mm. the spacing of successive wave crests 34 in terms of the centers of the latter is approximately 60 mm, for example.

FIG. 3 shows the diagram known substantially from FIG. 2, whereby the component 20 now is fastened to the joining region 26 of the first component 10. The fastening expediently takes place by joining by means of pressure welding, presently preferably in particular resistance spot welding. The welding spots 50 here are positioned on the wave crests 34, cf. also FIG. 2 to this end. As already mentioned, a spacing of the wave crests 34 is approximately 60 mm, at a lateral length of the “fields” of preferably approximately 20 mm×20 mm. The size of the fields, or of the wave crests 34, respectively, enables the welding spots 50 to be positioned or aligned in a reliable manner in terms of the process. The spacing of the fields or the wave crests 34 is designed such that the mechanical target values of the connection are achieved. It is particularly advantageous for a cement connection also to be used apart from the welded connection for joining the components 10 and 20. The cement can ideally extend into the wave troughs 36, or be disposed in the latter, respectively. Optimal adhesion or interlocking of the cement can be achieved by virtue of the roughness or porosity of the adhesive layer 30, caused by the application by means of spraying, this benefiting the strength of the component connection.

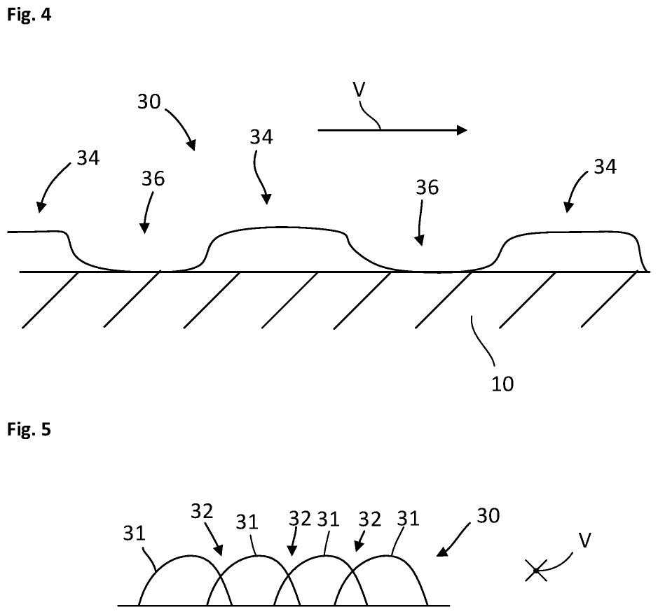

FIG. 4 in in a schematic view shows a section along an adhesive layer 30, disposed on a first component 10, when viewed along a displacement direction V of a coating tool. Schematically indicated is a wave profile comprising wave crests 34 and wave troughs 36. The adhesive layer 30 in the region of the wave crests 34 has a significantly greater wall thickness than therebetween. This is achieved in that a displacement speed of the coating tool is increased in the region of the wave troughs 36, for example. It can be clearly seen that the size of the adhesive layer 30 in the region of the wave troughs 36 can be reduced to a minimum by this method, this significantly lowering the weight and the material costs and thus the method costs. By way of a further adaptation of the method this could also be managed so that no coating material at all remains present in the region of the wave troughs 36, if desired. In this instance, an adhesive layer 30 is configured exactly only in the region of the wave crests 34. In terms of the afore-mentioned adhesive method however, an at least thin adhesive layer 30 in the region of the wave troughs 36 may offer great advantages because the surface in this region is increased on account of the roughness or porosity of the adhesive layer 30, which is associated with great advantages for a cement connection.

FIG. 5 schematically shows a cross section of an adhesive layer 30. The adhesive layer 30 in the present case is generated by a multiplicity of tracks 31 disposed next to one another. It can be seen that gaps 32 are formed between these tracks 31. The further apart the tracks 31, the larger the gaps 32. If welding now takes place over a structure of this type, welding spatters may be created among other things, cf. FIG. 1 to this end. The problem arises in particular when an electrode is positioned in the region of or above a “gap 31”. The method, by adapting the offset of the trace or track and/or a suitable choice of the nozzle diameter, is advantageously managed such that a uniform surface is achieved across the entire region of the adhesive layer 30, presently in particular in terms of the width direction, so that the welding spot can be set “arbitrarily”, so to speak.

### LIST OF REFERENCE CHARACTERS

10 First component
20 Second component
26 Joining region
30 Adhesive layer
31 Track, trace
32 Gap
34 Wave crest, plateau
36 Wave trough
40 Cement (layer)
50 Welding spot
60 Welding caps
70 Coating tool
V Displacement direction, advancement direction

1.-15. (canceled)

16. A method for joining components, comprising the steps of:
providing a first component, wherein the first component is an aluminum die-cast component and wherein the first component has a joining region for disposing and fastening a second component;
generating at least in regions an adhesive layer on the joining region by a thermal spraying method; and
fastening the second component to the adhesive layer by joining by pressure welding.

17. The method according to claim 16, wherein the pressure welding is resistance spot welding.

18. The method according to claim 16, wherein the thermal spraying method is cold gas spraying.

19. The method according to claim 16, wherein the adhesive layer extends along the joining region such that the adhesive layer along the joining region has a profiled surface, a structured surface, or a wave profile and wherein a region of a wave crest of the adhesive layer is resistance spot welded.

20. The method according to claim 19, wherein a ratio of a height of a wave crest to a height of a wave trough is in a range from 1.05 to 2.7.

21. The method according to claim 19, wherein the profiled surface, the structured surface, or the wave profile is generated by an adapted advancement speed while generating the adhesive layer.

22. The method according to claim 16, wherein the generating of the adhesive layer is by way of a material application in a plurality of tracks disposed next to one another.

23. The method according to claim 16, further comprising the step of fastening the second component to the joining region by additional joining by adhesive bonding.

24. The method according to claim 23, further comprising the step of applying cement to and/or beside the adhesive layer.

25. The method according to claim 24, wherein the cement is distributed while positioning the second component on the joining region and by a force introduction during the pressure welding.

26. The method according to claim 16, further comprising the steps of:
providing the first component with a surface treatment; and
removing in regions the surface treatment by and while generating the adhesive layer.

27. A component connection, comprising:
a first component, wherein the first component is comprised of an aluminum material; and
a second component, wherein the second component is comprised of a steel material, wherein the first component and the second component are fastened to one another along a joining region, and wherein the first component in the joining region at least in regions has an adhesive layer which is generated by a thermal spraying method;
wherein the second component is fastened to the adhesive layer by pressure welding.

28. The component connection according to claim 27, wherein the adhesive layer along the joining region has alternating wave crests and wave troughs and wherein at least one welding spot is respectively disposed on the wave crests.

29. The component connection according to claim 27, wherein a surface of the adhesive layer has an Sa value in a range from approximately 5 to 30 μm.

30. The component connection according to claim 27, wherein the first component and the second component are adhesively bonded at least in regions along the joining region.
